(19) United States
(12) Patent Application Publication
(10) Pub. No.: US 2015/0147731 A1
(43) Pub. Date: May 28, 2015

(54) Shifting visual attention between multiple video displays to train attention and memory

(71) Applicant: Julia Pavlovna Astafiev, Saint Louis, MO (US)

(72) Inventor: Julia Pavlovna Astafiev, Saint Louis, MO (US)

(21) Appl. No.: 14/275,882

(22) Filed: May 13, 2014

Related U.S. Application Data
(60) Provisional application No. 61/855,402, filed on May 15, 2013.

(51) Int. Cl. G09B 5/00; G11B 27/00; H04N 9/87; G09B 19/00

(52) U.S. Cl. CPC G09B 5/00; G09B 19/00; G11B 27/005; H04N 9/87
USPC 434/236; 386/343

(57) ABSTRACT

An apparatus comprising an electronic control device capable of sending commands to play, stop and pause the media content, at least 2 devices capable of playing and pausing the media content in communication with electronic control device and at least 2 devices capable of displaying the media content. A method of memory and attention training comprising the pausing the media content on all displays, except one that is randomly chosen.

### RELATED APPLICATIONS

This patent application claims priority from U.S. provisional patent application 61/855,402 filed on May 15, 2013, which is hereby incorporated by reference in its entirety.

### BACKGROUND

The present application relates generally to displaying the media content.

Old people frequently have depression, decreased memory and decreased multitasking abilities. Due to the decreased mobility they spend a lot of time watching TV at home. Existing training software for old people is usually in a form of a computer program and is boring or difficult to use, so there is a great need for training process allowing improving or preserving memory, multitasking abilities and preventing depression while watching the entertaining media content.

### SUMMARY

Several aspects of example of the invention are set out in the claims.

According to a first aspect of the present invention, an apparatus comprising an electronic control device capable of sending commands to play, stop or pause the media content; at least 2 devices capable of playing and pausing the media content in communication with electronic control device; and at least 2 devices capable

of displaying the media content.

According to a second aspect of the present invention, a method of memory and attention training comprising the pausing the presentation of the media content on all displays, except one that is randomly chosen.

### BRIEF DESCRIPTION OF THE DRAWINGS

FIG. 1 shows a schematic diagram of an example embodiment of the invention.

### DETAILED DESCRIPTION OF THE INVENTION

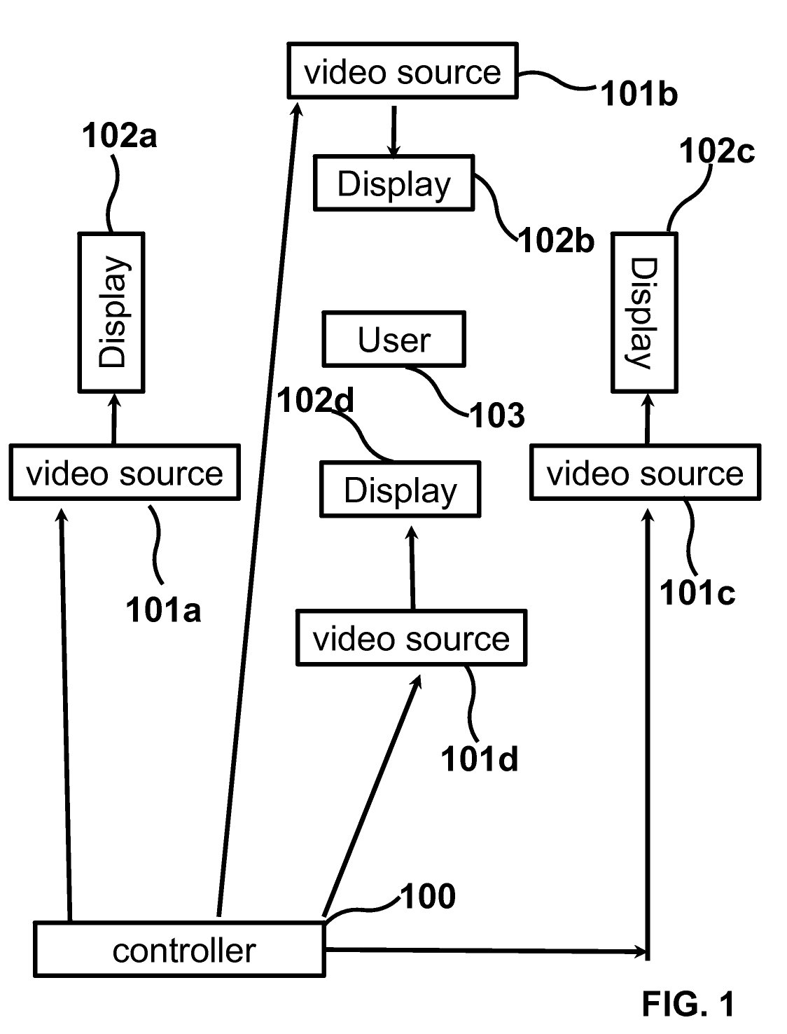

FIG. 1 is a schematic diagram of an example embodiment of the invention with four displays and four video sources.

Electronic controller 100 may include but is not limited to a mobile phone, a computer, a tablet, a personal digital assistant, a game console, universal remote control and/or the like. Video source 101a-d may include but is not limited to a mobile phone, a computer, a tablet, a game console, DVD or CD player, Blue-ray player, media player, VCR, online media player, streaming stick, streaming media player, satellite, cable or internet TV, and/or the like. Display 102a-d may include but is not limited to a tablet, TV, computer monitor, projector projecting on a screen and/or the like. Connections between displays, video sources and electronic controller can be wired or wireless. Wireless connection may include but is not limited to Wi-Fi, Bluetooth, WLAN or infrared. Media content displayed on Displays 102a-d may include but is not limited to a movie, TV show, sport content, video game and/or the like. Each media content is selected independently from other media contents.

If preferred, video source 101a-d and display 102a-d can be combined into one unit (may include but is not limited to a smart TV, tablet, computer, TV/DVD or TV/DVD/VCR combo and/or the like). If desired, video sources 101a-d and electronic controller 100 can be combined into one unit.

According to the specific program, the controller 100 will send the commands to play or to pause the media content on each video source 101a-d. Number of displays 102a-d with connected video sources 101a-d can range from 2 to 16. FIG. 1 shows an example embodiment with four displays and four 101a-d s. Only one video source will play the media content while the other video sources 101a-d will be paused by the controller.

The process starts with media contents paused on each video source 101a-d. Then the controller 100 sends a command to play a first media content on a first video source 101a displaying first media content on a first display 102a. After some delay (between 1 second and 1800 seconds) controller 100 sends a command to pause the first media content on the first video source 101a and to start playing a second media content on a second video source 101b displaying it on a second display 102b. Then after some delay (between 1 s and 1800 seconds) controller 100 sends a command to pause the second media content on the second video source 101b and start playing a third media content on a third video source 101c, displaying it on a third display 102c. Then after some delay (between 1 second and 1800 seconds) controller 100 sends a command to pause the third media content on the third video source 101c and start playing a fourth media content on a fourth video source 101d displaying it on a fourth display 102d. Then after some delay (between 1 second and 1800 seconds) controller 100 sends a command to pause the fourth media content on the fourth video source 101d and start playing one of the paused media content on randomly selected video source 101a-d with connected display 102a-d. This process (starting playing another media content on randomly selected video source after pausing the media content on the previous video source) will be repeated until all media contents will end playing on each display. The delay (between 1second and 1800 seconds) will become smaller each time, so the user 103 will need to switch attention faster and faster while keeping in memory the content presented in each display.

The minimum delay (between 1 second and 1800 seconds), the number of displays (from 2 to 16) around the user 103 and the media content to play will be selected for each user individually, so the training will not produce discomfort. Media content displayed on displays will be unfamiliar to the user.

Our invention will encourage the user 103 to make frequent shits of visual attention between the visual displays , while encouraging to keep in memory the media content presented in each display, so the user 103 can continue watching the media content in previously attended spatial location, remembering what was presented in this spatial location before. Frequent attention shifts may be useful to treat or prevent the depression too, so our invention describes a way to simultaneously improve memory and attention, increase multitasking abilities and probably to prevent or treat the depression while watching the media content. Our invention is easy to use in any setting (home, nursing home etc).

A user may specify in the settings of the controller 100 the number of video sources 101a-d with connected displays 102a-d to be used, the media content that will be played on each video source 101a-d and the minimal and maximal duration of the time each media content will be played on each video source 101a-d.

Embodiment of this invention may be at least partially implemented in software, hardware, application logic, or a combination of software, hardware and application logic.

If preferred, the different functions discussed herein may be performed in a different order and/or concurrently with each other. Furthermore, if desired, one or more of the above-described functions may be optional or may be combined.

It is also noted herein that while the above describes example embodiment of the invention, this description should not be viewed in a limiting sense. Rather, there are several variations and modifications which may be made without departing from the scope of the present invention.

What is claimed is:

1. An apparatus comprising:
an electronic control device capable of sending commands to play, stop or pause the media content;
at least 2 devices capable of playing and pausing the media content in communication with electronic control device; and
at least 2 devices capable of displaying the media content.

2. A method of memory and attention training comprising the pausing the presentation of the media content on all displays, except one that is randomly chosen.
